(19) United States
(12) Patent Application Publication
(10) Pub. No.: US 2026/0042403 A1
(43) Pub. Date: Feb. 12, 2026

(54) Vehicle-Mounted Bicycle Rack Device

(71) Applicant: Michael Afolabi, Brookhaven, PA (US)

(72) Inventor: Michael Afolabi, Brookhaven, PA (US)

(21) Appl. No.: 19/266,531

(22) Filed: Jul. 11, 2025

Related U.S. Application Data
(60) Provisional application No. 63/681,770, filed on Aug. 9, 2024.

(51) Int. Cl. B60R 9/10; B60R 9/042

(52) U.S. Cl. CPC B60R 9/10; B60R 9/042

(57) ABSTRACT

A vehicle-mounted bicycle rack device is provided that facilitates the mounting and transport of bicycles on a vehicle's roof without requiring the user to manually lift the bike overhead or remove any components. More specifically, the device attaches securely to existing roof rack bars via a horizontal cross member with fasteners that engage the roof rack bars. A vertical track supports a rotating frame member, which slides and pivots downward by approximately 90 degrees to a deployed position parallel to the vehicle's side. A secondary frame arm extends outward from the rotating frame member, featuring at least one bike hanger that pivots between stowed and extended positions. The hanger includes a contoured receiving area with an adjustable strap for securing the bicycle. To store the bike, the user reverses the deployment process, lifting the rotating frame member back into the vertical track, positioning the bicycle flat on the roof.

### CROSS-REFERENCE TO RELATED APPLICATION

The present application claims priority to, and the benefit of, U.S. Provisional Application No. 63/681,770, which was filed on Aug. 9, 2024, and is incorporated herein by reference in its entirety.

### FIELD OF THE INVENTION

The present invention relates generally to the field of vehicle-mounted bicycle racks. More specifically, the present invention relates to a vehicle-mounted bicycle rack that attaches securely to existing roof rack bars and features a rotating frame member that pivots downward for easy bike loading without manual overhead lifting or component removal. Accordingly, the present disclosure makes specific reference thereto. Nonetheless, it is to be appreciated that aspects of the present invention are also equally applicable to other like applications, devices, and methods of manufacture.

### BACKGROUND

Transporting bicycles using vehicle-mounted racks presents several challenges for users. Traditional roof-mounted bike racks often require the user to lift the bicycle to a significant height, making installation difficult, particularly for individuals with limited strength or mobility. Additionally, many existing designs necessitate the removal of the bicycle's front tire, adding complexity to the mounting process. A further issue arises when bicycles are transported in an upright position, as this configuration increases the risk of damage when encountering low-clearance obstacles such as garages, tunnels, or bridges. Side-mounted bicycle racks exist, but many do not provide a stable and secure mechanism for easy loading and unloading. Some require additional platforms or accessories to facilitate mounting, which adds to the overall cost and effort required for operation. Moreover, conventional bike racks may not adequately secure the bicycle, leading to potential instability during transportation. Given these limitations, there is a need for an improved vehicle-mounted bike rack that allows for convenient mounting and dismounting without requiring additional equipment or significant physical effort.

Therefore, there exists a long-felt need in the art for a vehicle-mounted bicycle rack device that enables users to mount and dismount a bicycle without requiring significant lifting effort or the removal of bicycle components. There also exists a long-felt need in the art for a vehicle-mounted bicycle rack device that allows a bicycle to be transported in a flat position to minimize the risk of damage when encountering low-clearance obstacles. Moreover, there exists a long-felt need in the art for a vehicle-mounted bicycle rack device that provides a secure and stable mounting system while maintaining a compact and aerodynamic profile when not in use.

The subject matter disclosed and claimed herein, in one embodiment thereof, comprises a vehicle-mounted bicycle rack device. The device is comprised of a vehicle-mounted bicycle rack that facilitates the mounting and transport of bicycles on a vehicle's roof without requiring the user to manually lift the bike overhead or remove any components. More specifically, the device attaches securely to existing roof rack bars via a horizontal cross member with fasteners that engage the roof rack bars. A vertical track supports a rotating frame member, which slides and pivots downward by approximately 90 degrees to a deployed position parallel to the vehicle's side. A secondary frame arm extends outward from the rotating frame member, featuring at least one bike hanger that pivots between stowed and extended positions. The hanger includes a contoured receiving area with an adjustable strap for securing the bicycle. To store the bike, the user reverses the deployment process, lifting the rotating frame member back into the vertical track, positioning the bicycle flat on the roof. A locking release mechanism ensures stability in various positions, preventing unintended movement during transport.

In this manner, the vehicle-mounted bicycle rack device of the present invention accomplishes all the foregoing objectives and provides a user-friendly mounting device that allows a bicycle to be loaded and unloaded from a vehicle roof from the side of a vehicle without having to remove parts of the bicycle. More specifically, the rotating frame member slides along the track and pivots downward, enabling easy access to the bicycle hanger without requiring the user to lift the bicycle onto the vehicle's roof. Additionally, the design ensures that the bicycle remains in a flat position during transportation, reducing the risk of damage to the vehicle rooftop, and from low-hanging obstacles. The adjustable mounting arms and secure locking mechanisms provide stability and prevent unintended movement, ensuring safe transport. Furthermore, when not in use, the device maintains a compact profile that minimizes aerodynamic drag and interference with vehicle operation.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle-mounted bicycle rack device. The device is a bike rack that facilitates mounting a bicycle onto a vehicle without requiring manual lifting or removal of bike components. More specifically, it attaches to existing roof rack bars via a horizontal cross member secured with at least one fastener that engages a corresponding channel on the roof rack bar. A vertical track extends perpendicularly across the horizontal cross member, serving as a guide for a rotating frame member that slides along the track in a controlled manner. At the end of the track, a pivot point allows the rotating frame member to rotate downward by approximately 90 degrees, transitioning from a stowed position parallel to the track to a deployed position perpendicular to it. In this deployed position, the rotating frame member and an attached secondary frame arm align generally parallel to the vehicle's side.

The secondary frame arm extends outward from the rotating frame member and serves as a mounting point for at least one bike hanger. In one embodiment, two adjustable secondary frame arms accommodate bicycles of different frame widths. The bike hanger is pivotally connected to the secondary frame arm and articulates between a stowed and an extended position. In the extended position, the bike hanger supports at least one bicycle by securing a structural component of the bike in a contoured receiving area. At least one adjustable strap, incorporating a tightening and release mechanism, secures the bicycle in place.

In the stowed configuration, the rotating frame member remains flush within the vertical track, while the secondary frame arm and bike hanger fold into a compact, aerodynamic position. Deployment involves pulling the rotating frame member outward via a handle until it reaches the pivot point, where it pivots downward. The bike hanger is then extended, allowing a bicycle to be placed in the receiving area and secured with the adjustable strap.

To stow the bike and device, the process is reversed. The rotating frame member pivots upward and inward into the vertical track, positioning the secured bicycle flat atop the vehicle. A locking release mechanism secures the rotating frame member in different positions, preventing unintended movement during transport. The locking mechanism may include a latch, spring-loaded pin, or similar locking component that automatically engages at designated positions, requiring manual actuation to transition between them.

A method of using the device includes providing the components, securing the device to the vehicle's roof rack bars, deploying the rotating frame member and bike hanger, placing and securing a bicycle, and stowing the assembly by pivoting the frame member and engaging the locking mechanism to ensure safe transport.

Accordingly, the vehicle-mounted bicycle rack device of the present invention is particularly advantageous as it provides a user-friendly mounting device that allows a bicycle to be loaded and unloaded from a vehicle roof from the side of a vehicle without having to remove parts of the bicycle. More specifically, the rotating frame member slides along the track and pivots downward, enabling easy access to the bicycle hanger without requiring the user to lift the bicycle onto the vehicle's roof. Additionally, the design ensures that the bicycle remains in a flat position during transportation, reducing the risk of damage from low-hanging obstacles. The adjustable mounting arms and secure locking mechanisms provide stability and prevent unintended movement, ensuring safe transport. Furthermore, when not in use, the device maintains a compact profile that minimizes aerodynamic drag and interference with vehicle operation. In this manner, the vehicle-mounted bicycle rack device overcomes the limitations of existing bicycle vehicle-mounting devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle-mounted bicycle rack device of the present invention while attached to a vehicle and while in a stowed position in accordance with the disclosed architecture;

FIG. 2 illustrates a perspective view of one potential embodiment of a vehicle-mounted bicycle rack device of the present invention while attached to a vehicle and while a bicycle is attached to the device in a loading position in accordance with the disclosed architecture;

FIG. 3 illustrates a perspective view of one potential embodiment of a vehicle-mounted bicycle rack device of the present invention while attached to a vehicle and while a bicycle is attached to the device in a stowed position in accordance with the disclosed architecture; and

FIG. 4 illustrates a flowchart of a method of using one potential embodiment of a vehicle-mounted bicycle rack device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle-mounted bicycle rack device that enables users to mount and dismount a bicycle without requiring significant lifting effort or the removal of bicycle components. There also exists a long-felt need in the art for a vehicle-mounted bicycle rack device that allows a bicycle to be transported in a flat position to minimize the risk of damage when encountering low-clearance obstacles. Moreover, there exists a long-felt need in the art for a vehicle-mounted bicycle rack device that provides a secure and stable mounting system while maintaining a compact and aerodynamic profile when not in use.

The present invention, in one exemplary embodiment, is comprised of a vehicle-mounted bicycle rack device. The device is a bike rack designed to mount a bicycle onto a vehicle without requiring manual lifting or removal of bike components and attaches to the existing roof rack bars via a horizontal cross member, which is secured with at least one fastener that engages a corresponding channel on the roof rack bar. A vertical track extends perpendicularly across the horizontal cross member, guiding a rotating frame member that slides along the track in a controlled manner. At the end of the track, a pivot point enables the rotating frame member to rotate downward by approximately 90 degrees, transitioning from a stowed position parallel to the track to a deployed position perpendicular to it. In this deployed position, the rotating frame member and an attached secondary frame arm are generally aligned parallel to the vehicle's side.

The secondary frame arm extends outward from the rotating frame member and serves as a mounting point for at least one bike hanger. In one embodiment, two adjustable secondary frame arms accommodate bicycles of varying frame widths. The bike hanger is pivotally connected to the secondary frame arm, allowing articulation between a stowed and an extended position. In the extended position, the bike hanger supports at least one bicycle by securing a structural component of the bike within a contoured receiving area. At least one adjustable strap, equipped with a tightening and release mechanism, secures the bicycle in place.

In the stowed configuration, the rotating frame member remains flush within the vertical track, while the secondary frame arm and bike hanger fold into a compact, aerodynamic position also, allowing for the mounting of other devices. Deployment involves pulling the rotating frame member outward via a handle until it reaches the pivot point, where it pivots downward. The bike hanger is then extended, allowing a bicycle to be positioned in the receiving area and secured with the adjustable strap.

To stow the bike and device, the process is reversed. The rotating frame member pivots upward and inward into the vertical track, positioning the secured bicycle flat atop the vehicle. A locking release mechanism secures the rotating frame member in multiple positions, preventing unintended movement during transport. The locking mechanism may include a latch, spring-loaded pin, or similar locking component that automatically engages at designated positions, requiring manual actuation to transition between them.

A method of using the device includes providing the necessary components, attaching the device to the vehicle's roof rack bars, deploying the rotating frame member and bike hanger, positioning and securing a bicycle, and returning the assembly to the stowed configuration by pivoting the frame member and engaging the locking mechanism to ensure safe transport.

The vehicle-mounted bicycle rack device offers a user-friendly solution for loading and unloading a bicycle from a vehicle roof from the side of the vehicle without removing any bicycle components. The rotating frame member slides along the track and pivots downward, providing easy access to the bike hanger without requiring the user to lift the bicycle onto the roof. The design maintains the bicycle in a flat position during transport, reducing the risk of damage from low-hanging obstacles. Adjustable mounting arms and secure locking mechanisms enhance stability and prevent unintended movement, ensuring safe transport. When not in use, the device maintains a compact profile, minimizing aerodynamic drag and interference with vehicle operation. In this way, the device addresses the limitations of existing vehicle-mounted bicycle racks.

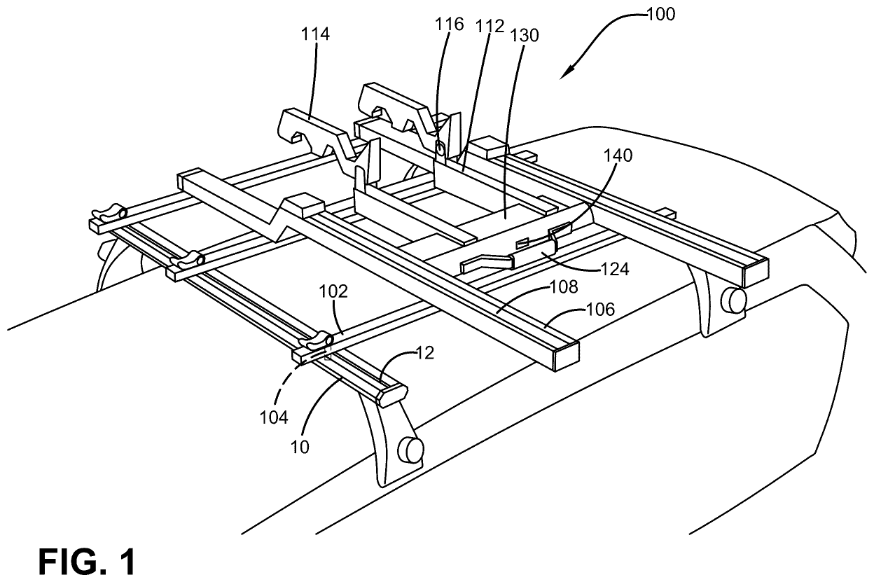

Referring initially to the drawings, FIG. 1 illustrates a perspective view of one potential embodiment of a vehicle-mounted bicycle rack device 100 of the present invention while attached to a vehicle 10 and while in a stowed position in accordance with the disclosed architecture. The device 100 is a bike rack that eliminates the need for a user to manually place a bike on top of a vehicle unaided and remove any component of a bike before mounting.

The device 100 attaches to the existing roof rack bars 10 of a vehicle and is secured to the roof rack bar via at least one horizontal cross member 102 that extends laterally across the roof rack bars 10. The horizontal cross member 102 is comprised of at least one fastener 104, such as, but not limited to, a male T-slot fastener, which is configured to engage with a corresponding T-slot channel 12 (or other similar channel) on the roof rack bar 10.

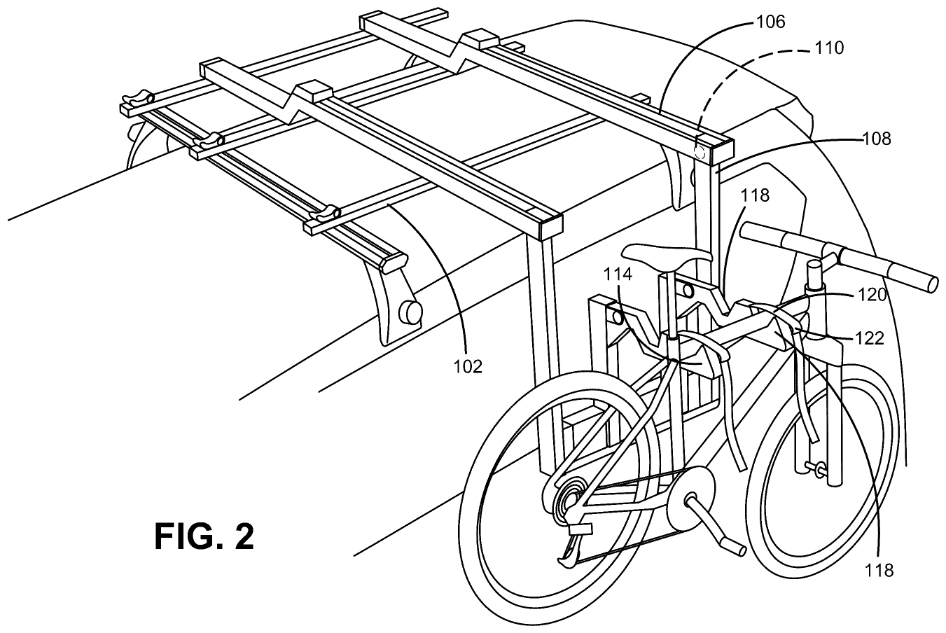

At least one track 106 is positioned generally perpendicular across the horizontal cross member 102, The track 106 serves as a guiding structure for a rotating frame member 108, which is movably captured within the track 106. The rotating frame member 108 is configured to slide along the vertical track 106 parallel with the roof rack bar 10 in a controlled manner. The end of the track 106 is further comprised of a pivot point 110 located at the end of the track 106, to which the rotating frame member 108 is also connected. As the rotating frame member 108 reaches the end of the track 106, the pivot point 110 enables the rotating frame member 108 to rotate downward (i.e., towards a ground surface) by approximately 90 degrees, as seen in FIG. 2. This movement transitions the rotating frame member 108 from a stowed position, where it is aligned generally parallel to the track 106 as seen in FIG. 1, to a deployed position, where it extends perpendicular to a horizontal axis of the track 106 in the downward direction, as seen in FIG. 2.

In this deployed position, the rotating frame member 108 and an attached secondary frame arm 112 are positioned generally parallel to a side wall of the vehicle the device 100 is secured to. The secondary frame arm 112 extends outward from the rotating frame member 108 and serves as a mounting point for at least one bike hanger 114. In one embodiment, the device 100 includes at least one (but preferably two) secondary frame arms 112 that are adjustable along a horizontal cross member 130. This configuration allows for two bike hangers 114 to be mounted at customizable distances along the cross member 130, enabling the accommodation of bicycles with different frame widths.

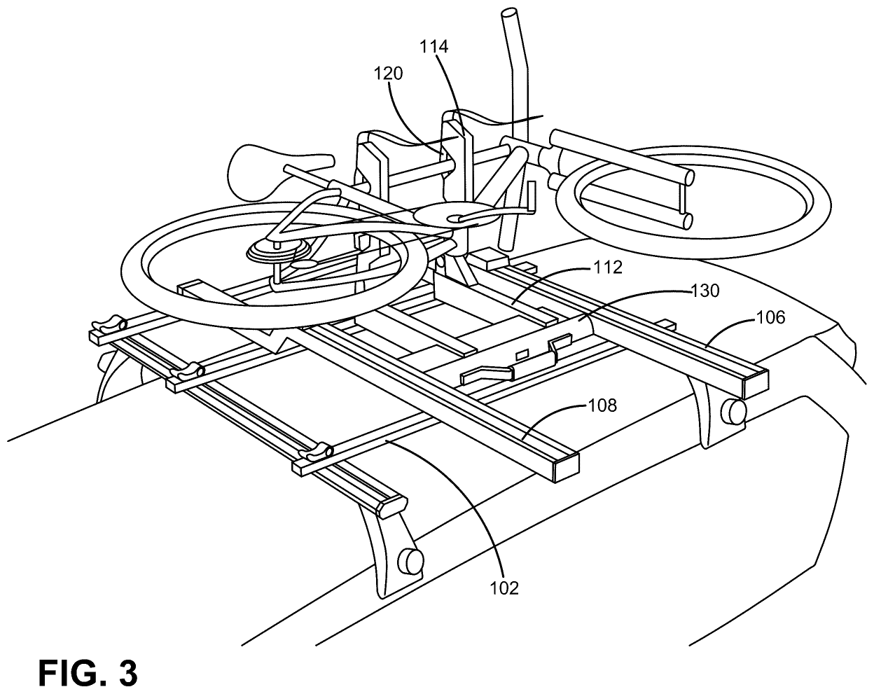

The bike hanger 114 is pivotally connected to the secondary frame arm 112 through a pivot point 116 such as, but not limited to, a hinge, allowing the bike hanger 114 to articulate between a stowed position as seen in FIG. 1 and an extended position in FIG. 2 and FIG. 3. In the extended position, the bike hanger 114 is oriented perpendicular to a vertical axis of the secondary frame arm 112, enabling at least one bicycle to be supported by the bike hanger 114. The bike hanger 114 includes at least one receiving area 118, which is contoured to receive and cradle a portion of a bicycle frame, wheel, or other structural component of the bicycle. At least one adjustable strap 120 is integrated into the bike hanger 114 to secure the bicycle within the area 118, preventing unintended movement or dislodgement during transport. The strap 120 may be comprised of a flexible, high-strength material and may incorporate a tightening and release mechanism 122 such as, but not limited to, a ratcheting or buckle mechanism.

In the stowed configuration, the rotating frame member 108 remains flush within the vertical track 106 as seen in FIG. 1, maintaining a compact profile that is generally parallel to the track 106. The secondary frame arm 112 and the bike hanger 114 are also folded into a flat orientation, generally parallel to the track 106 as seen in FIG. 1, to minimize aerodynamic drag and reduce interference with vehicle operation. To deploy the device 100, the rotating frame member 108 is pulled outward from the track 106 toward a user standing beside the vehicle via at least one handle 124. As the rotating frame member 108 reaches the end of the track 106, the rotating frame member 108 to pivots downward around the pivot point 110, as seen in FIG. 2. In this deployed position, the rotating frame member 108 and the secondary frame arm 112 are aligned generally parallel to a side wall of the vehicle the device 100 is installed on. Once the member 108 and frame arm 112 are in the deployed configuration, the bike hanger 114 is unfolded from the secondary frame arm such that the hanger 114 extends outward in a direction perpendicular to the vertical axis of the secondary frame arm 112, as seen in FIG. 2. A bicycle is then positioned onto the bike hanger 114 by placing a structural component of the bicycle, such as a frame tube or wheel, into the receiving area 118 of the hanger 114. The adjustable strap 120 is then engaged to secure the bicycle within the area 114.

After the bicycle is secured in the hanger 114, the deployment process is reversed to return the device 100 to the stowed position atop a vehicle, as seen in FIG. 3. More specifically, the rotating frame member 108 is rotated upwards and inwards (toward the center of the vehicle roof) back into the vertical track 106. As a result, the secured bicycle is then placed in a flat position atop the vehicle, with the bicycle resting on its side and generally parallel to the roof surface.

A locking release mechanism 140 is also incorporated into the device 100 to secure the rotating frame member 108 in different positions, preventing unintended movement during transport or deployment. More specifically, the locking release mechanism 140 is configured to be activated by the user when the rotating frame member 108 is in the stowed position, the fully extended position along the track, and the rotated position where the frame member is perpendicular to the track. This mechanism 140 may include a latch, spring-loaded pin, or other locking component that automatically engages when the rotating frame member 108 reaches a designated position. To transition between positions, the user manually actuates the locking release mechanism 140 to disengage the lock, allowing controlled movement of the rotating frame member 108.

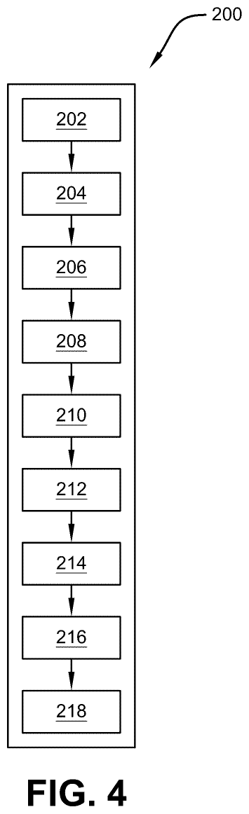

The present invention is also comprised of a method of using 200 the device 100, as seen in FIG. 4. First, a device 100 is provided, which comprises at least one horizontal cross member 102, at least one vertical track 106, a rotating frame member 108, at least one secondary frame arm 112, and at least one bike hanger 114 [Step 202]. Next, the device 100 is attached to the existing roof rack bars 10 of a vehicle by securing the horizontal cross member 102 to the roof rack bars 10 via at least one fastener 104 that engages with a corresponding channel 12 on the bar 10 [Step 204]. Then, the rotating frame member 108 is pulled outward from the track 106 via at least one handle 124 until it reaches the pivot point 110 at the end of the track 106 [Step 206]. The rotating frame member 108 is then pivoted downward by approximately 90 degrees, transitioning from a stowed position to a deployed position where it is generally parallel to a side wall of the vehicle [Step 208]. Next, the bike hanger 114 is unfolded from the secondary frame arm 112 to extend outward in a direction perpendicular to the vertical axis of the secondary frame arm 112 [Step 210]. A bicycle is then positioned onto the bike hanger 114 by placing a structural component of the bicycle, such as a frame tube or wheel, into the receiving area 118 of the hanger 114 [Step 212]. Once the bicycle is positioned, at least one adjustable strap 120 is engaged to secure the bicycle within the receiving area 118, preventing unintended movement or dislodgement during transport [Step 214]. After securing the bicycle, the rotating frame member 108 is pivoted upward and inward (toward the center of the vehicle roof) back into the vertical track 106, thereby lifting the secured bicycle onto the roof of the vehicle in a generally flat position [Step 216]. Finally, a locking release mechanism 140 is engaged to secure the rotating frame member 108 in the stowed position, preventing unintended movement of the device 100 and ensuring safe transport of the bicycle [Step 218].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle-mounted bicycle rack device” and “device” are interchangeable and refer to the vehicle-mounted bicycle rack device 100 of the present invention.

Notwithstanding the foregoing, the vehicle-mounted bicycle rack device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle-mounted bicycle rack device 100 as shown in the FIGS. are for illustrative purposes only, and that many other sizes and shapes of the vehicle-mounted bicycle rack device 100 are well within the scope of the present disclosure. Although the dimensions of the vehicle-mounted bicycle rack device 100 are important design parameters for user convenience, the vehicle-mounted bicycle rack device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle-mounted bicycle rack device comprising:
a horizontal cross member configured to attach to a roof rack bar of a vehicle, the horizontal cross member comprised of a first fastener configured to engage with a corresponding channel on the roof rack bar;
a track positioned generally perpendicular to the horizontal cross member;
a rotating frame member movably captured within the track, wherein the rotating frame member is configured to slide along the track;
a pivot point located at an end of the track, the pivot point configured to enable the rotating frame member to rotate downward from a stowed position to a deployed position;
a secondary frame arm attached to the rotating frame member; and
a bike hanger pivotally connected to the secondary frame arm, the bike hanger configured to articulate between a stowed position and an extended position, wherein the bike hanger is comprised of a receiving area configured to receive a portion of a bicycle.

2. The vehicle-mounted bicycle rack device of claim 1, wherein the first fastener is comprised of a T-slot fastener.

3. The vehicle-mounted bicycle rack device of claim 1, wherein the bike hanger is comprised of a hinge.

4. The vehicle-mounted bicycle rack device of claim 1, wherein the rotating frame member is comprised of a handle.

5. The vehicle-mounted bicycle rack device of claim 1 further comprised of a locking release mechanism.

6. The vehicle-mounted bicycle rack device of claim 5, wherein the locking release mechanism secures the rotating frame member in a stowed position along the track.

7. The vehicle-mounted bicycle rack device of claim 5, wherein the locking release mechanism secures the rotating frame member in an extended position along the track.

8. The vehicle-mounted bicycle rack device of claim 1, wherein the receiving area is contoured.

9. A vehicle-mounted bicycle rack device comprising:
a horizontal cross member configured to attach to a roof rack bar of a vehicle, the horizontal cross member comprised of a first fastener configured to engage with a corresponding channel on the roof rack bar;
a track positioned generally perpendicular to the horizontal cross member;
a rotating frame member movably captured within the track, wherein the rotating frame member is configured to slide along the track;
a pivot point located at an end of the track, the pivot point configured to enable the rotating frame member to rotate downward from a stowed position to a deployed position;
a secondary frame arm attached to the rotating frame member;
a bike hanger pivotally connected to the secondary frame arm, the bike hanger configured to articulate between a stowed position and an extended position;
wherein the bike hanger is comprised of a receiving area configured to receive a portion of a bicycle; and
further wherein the bike hanger is comprised of an adjustable strap.

10. The vehicle-mounted bicycle rack device of claim 9, wherein the first fastener is comprised of a T-slot fastener.

11. The vehicle-mounted bicycle rack device of claim 9, wherein the bike hanger is comprised of a hinge.

12. The vehicle-mounted bicycle rack device of claim 9, wherein the rotating frame member is comprised of a handle.

13. The vehicle-mounted bicycle rack device of claim 9 further comprised of a locking release mechanism.

14. The vehicle-mounted bicycle rack device of claim 13, wherein the locking release mechanism secures the rotating frame member in a stowed position along the track.

15. The vehicle-mounted bicycle rack device of claim 13, wherein the locking release mechanism secures the rotating frame member in an extended position along the track.

16. The vehicle-mounted bicycle rack device of claim 9, wherein the receiving area is contoured.

17. A method of using a vehicle-mounted bicycle rack device, the method comprising the following steps:
providing a vehicle-mounted bicycle rack device comprised of a horizontal cross member, a track, a rotating frame member, a secondary frame arm, and a bike hanger;
attaching the bicycle rack device to a roof rack bar of a vehicle by securing the horizontal cross member to the roof rack bar via a first fastener engaging with a channel on the roof rack bar;
pulling the rotating frame member outward from the track until the rotating frame member reaches a pivot point at an end of the track;
pivoting the rotating frame member downward about the pivot point from a stowed position to a deployed position;
unfolding the bike hanger from the secondary frame arm to extend outward;
positioning a bicycle onto the bike hanger by placing a portion of the bicycle into a receiving area of the bike hanger;
securing the bicycle within the receiving area using an adjustable strap;
pivoting the rotating frame member upward and inward back into the track, thereby lifting the bicycle onto a roof of the vehicle; and
engaging a locking release mechanism to secure the rotating frame member in the stowed position.

18. The method of using a vehicle-mounted bicycle rack device of claim 17 further comprising a step of articulating the bike hanger between a stowed position and an extended position via a hinge before positioning the bicycle onto the bike hanger.

19. The method of using a vehicle-mounted bicycle rack device of claim 17 further comprising a step of pulling the rotating frame member outward from the track via a handle.

20. The method of using a vehicle-mounted bicycle rack device of claim 17, wherein pivoting the rotating frame member downward comprises rotating the rotating frame member by approximately 90 degrees at the pivot point.
